(19) United States
(12) Patent Application Publication
(10) Pub. No.: US 2016/0125404 A1
(43) Pub. Date: May 5, 2016

(54) FACE RECOGNITION BUSINESS MODEL AND METHOD FOR IDENTIFYING PERPETRATORS OF ATM FRAUD

(71) Applicant: Xerox Corporation, Norwalk, CT (US)

(72) Inventors: BRYAN J. ROOF, NEWARK, NY (US); ANDREW S. YEH, HONOLULU, HI (US); HOWARD A. MIZES, PITTSFORD, NY (US); HAITAO DU, ASHBURN, VA (US); MING YANG, FAIRPORT, NY (US)

(21) Appl. No.: 14/529,399

(22) Filed: Oct. 31, 2014

(51) Int. Cl. G06Q 20/40; G06F 17/30; G06Q 20/20; G06K 9/00

(52) U.S. Cl. CPC G06Q 20/40; G06K 9/00288; G06F 17/3028; G06Q 20/206

(57) ABSTRACT

A system and method for identifying perpetrators of ATM fraud. A subscription fee is collected for defined services for collecting, processing, and analyzing facial data. Facial data is acquired from a person conducting a transaction with an automated transaction system having a camera device. The facial data is linked to a transaction identifier including at least time and location associated with the transaction. The facial data and the transaction identifier are stored in a centralized repository. Upon request from an authorized subscriber to identify the person based on the transaction identifier, because the transaction is deemed fraudulent, the facial data associated with the transaction identifier is compared to facial profiles obtained from private, public, and law enforcement databases. Potential identity matches are generated based on the facial profiles. The potential identity matches are output to the authorized subscriber for further prosecutorial and/or investigative actions.

### BACKGROUND

Systems and methods herein generally relate to facial recognition, and more particularly, to methods for identifying perpetrators of ATM fraud.

Currently there are multiple forms of ATM fraud. In most cases however, debit card information available on the magnetic stripe as well as the PIN number must be obtained in order to access a cardholder's account on the machine. Typically, in order to withdraw funds from a compromised account, a fraudster will go to a physical ATM location, enter a duplicate card with the copied card magnetic information and enter the PIN code. While many ATMs have video cameras observing transactions, the video turns out to be not too useful because there is no linkage between the video and methods by which to identify the perpetrator. Currently, the video is used primarily to ascertain whether the actual cardholder conducted the transaction. Catching the actual perpetrator of the fraud usually falls on the card issuing institution. Generally, the card issuing institution would rely on disabling the card to limit further loss as opposed to finding and prosecuting the perpetrator. Furthermore, since an ATM used to dispense funds is frequently not the issuing bank and since the location of the ATM does not have any financial impact from the fraud action if it is not the issuing bank, there is little incentive to expend resources needed to provide the video for prosecution purposes.

### SUMMARY

According to one exemplary system herein, an automated transaction system comprises a camera device acquiring facial data from a person located within visual range of the camera device during a transaction between the person and the automated transaction system. The facial data comprises an image obtained by the camera device. A server is operatively connected to the automated transaction system. The server receives the facial data from the automated transaction system. The server links the facial data to a transaction identifier associated with the transaction. The transaction identifier comprises at least time and location of the transaction. A centralized repository is operatively connected to the server. A first network connects the server with the centralized repository. The centralized repository stores the facial data and the transaction identifier. A facial recognition processor is operatively connected to the centralized repository. A second network connects the facial recognition processor to public and law enforcement databases. Upon receiving a request from an authorized subscriber to identify the person based on the transaction identifier, the facial recognition processor compares the facial data associated with the transaction identifier to facial profiles from the public and law enforcement databases. The facial recognition processor generates potential identity matches based on the facial profiles. The facial recognition processor outputs the potential identity matches to the authorized subscriber.

According to an exemplary method, facial data is acquired from a person conducting a transaction with an automated transaction system. The automated transaction system comprises a camera device. The facial data comprises an image obtained by the camera device. The facial data is linked to a transaction identifier associated with the transaction. The transaction identifier comprises at least time and location of the transaction. The facial data and the transaction identifier are stored in a centralized repository connected to the automated transaction system. The facial data associated with the transaction identifier is compared to facial profiles from public and law enforcement databases. Potential identity matches are generated based on the facial profiles.

According to another exemplary method, a subscription fee is collected for defined services for collecting, processing, and analyzing facial data. Facial data is acquired from a person conducting a transaction with an automated transaction system. The automated transaction system comprises a camera device. The facial data comprises an image obtained by the camera device. The facial data is linked to a transaction identifier associated with the transaction. The transaction identifier comprises at least time and location of the transaction. The facial data and the transaction identifier are stored in a centralized repository connected to the automated transaction system. A request from an authorized subscriber is received to identify the person based on the transaction identifier. The transaction is deemed fraudulent. The facial data associated with the transaction identifier is compared to facial profiles obtained from public and law enforcement databases. Potential identity matches are generated based on the facial profiles. The potential identity matches are output to the authorized subscriber for further prosecutorial and/or investigative actions.

According to a computer system for enabling a method for identifying perpetrators of ATM fraud, the computer system comprises a program product comprising a tangible computer readable storage medium having program code embodied therewith. The program code is readable and executable by a computer to provide an application to perform a method. According to the method, facial data is acquired from a person conducting a transaction with an automated transaction system. The automated transaction system comprises a camera device. The facial data comprises an image obtained by the camera device. The facial data is linked to a transaction identifier associated with the transaction. The transaction identifier comprises at least time and location of the transaction. The facial data and the transaction identifier are stored in a centralized repository connected to the automated transaction system. The facial data associated with the transaction identifier is compared to facial profiles from public and law enforcement databases. Potential identity matches are generated based on the facial profiles.

These and other features are described in, or are apparent from, the following detailed description.

### BRIEF DESCRIPTION OF THE DRAWINGS

Various examples of the systems and methods are described in detail below, with reference to the attached drawing figures, which are not necessarily drawn to scale and in which:

FIG. 1 is a block diagram of a network according to systems and methods herein;

FIG. 2 is a block diagram of a system according to systems and methods herein;

FIG. 3 illustrates examples of information exchange according to systems and methods herein;

FIG. 4 is a flow diagram illustrating methods herein;

FIG. 5 is a schematic diagram illustrating devices herein; and

FIG. 6 is a schematic diagram illustrating systems herein.

### DETAILED DESCRIPTION

For a general understanding of the features of the disclosure, reference is made to the drawings. In the drawings, like reference numerals have been used throughout to identify identical elements. While the disclosure will be described hereinafter in connection with specific devices and methods thereof, it will be understood that limiting the disclosure to such specific devices and methods is not intended. On the contrary, it is intended to cover all alternatives, modifications, and equivalents as may be included within the spirit and scope of the disclosure as defined by the appended claims.

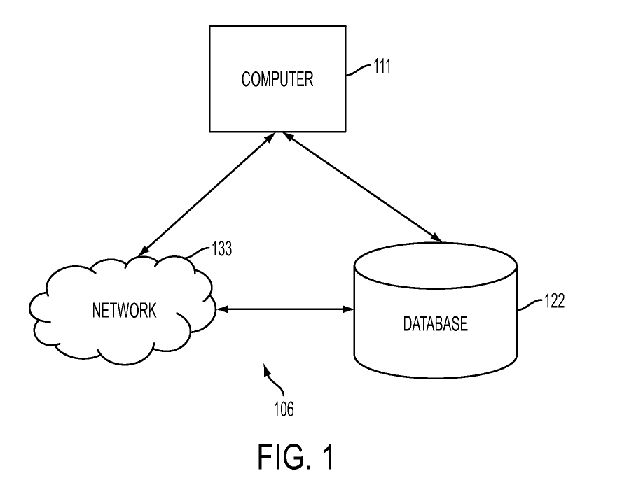

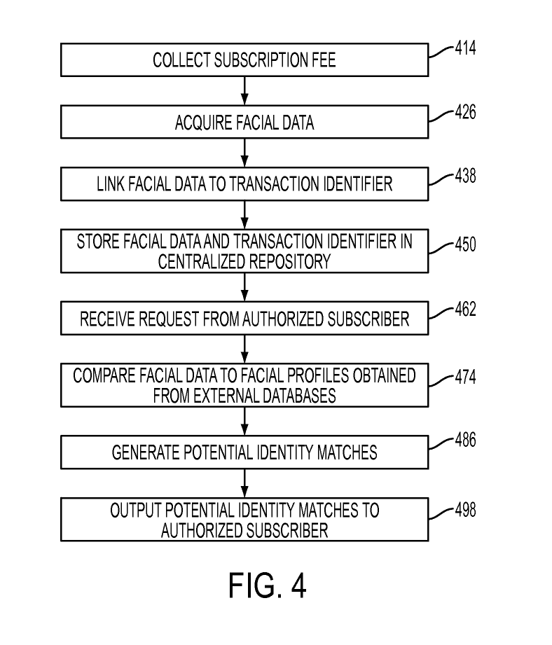

FIG. 1 is a general overview block diagram of a network, indicated generally as 106, for communication between a computer 111 and a database 122. The computer 111 may comprise any form of processor as described in further detail below. The computer 111 can be programmed with appropriate application software to implement the methods described herein. Alternatively, the computer 111 is a special purpose machine that is specialized for processing image data and includes a dedicated processor that would not operate like a general purpose processor because the dedicated processor has application specific integrated circuits (ASIC's) that are specialized for the handling of image processing operations, processing image data, comparing acquired image data to stored images from external sources, etc. In one example, the computer 111 is special purpose machine that includes a specialized video card having unique ASIC's for providing clear image processing, includes specialized boards having unique ASIC's for input and output devices to speed network communications processing, a specialized ASIC processor that performs the logic of the methods described herein (such as the processing shown in FIG. 4) using dedicated unique hardware logic circuits, etc.

Database 122 includes any database or any set of records or data that the computer 111 desires to retrieve. Database 122 may be any organized collection of data operating with any type of database management system. The database 122 may contain matrices of datasets comprising multi-relational data elements.

The database 122 may communicate with the computer 111 directly. Alternatively, the database 122 may communicate with the computer 111 over network 133. The network 133 comprises a communication network either internal or external, for affecting communication between the computer 111 and the database 122. For example, network 133 may comprise a local area network (LAN) or a global computer network, such as the Internet.

Disclosed herein are methods and systems to provide an ATM or Point of Sale video storage process/facility that will many a transaction identifier, which may include location, transaction time, and transaction number for a particular transaction, with a video for the transaction. If a financial institution reports an ATM fraud, the transaction information can be used to retrieve video based on the time, ATM location, and transaction identifier. Facial recognition is performed on that video and the images are compared to privately and publicly available databases, such as Facebook, as well as law enforcement agency databases. A ranked listing of links to potential matches is then generated. The list of potential matches and the original video and/or images can then be forwarded to human intelligence to further investigate and identify the identity of the face. Financial institutions will have financial incentive to participate due to two sources of revenue. One source is reduction of their own losses by reducing fraud through deterrence and through restitution of prosecuted cases. Another source of revenue is a percentage of recovered fees for video obtained from the financial institution's ATM, but perpetrated on another financial institution.

Every time a debit card or credit card is used, there is an exchange of data between the terminal and the card management service. The process of reading the card may involve passing the magnetic stripe over a magnetic reading head or bringing a chip in contact or near contact with a card reader. The information from the card itself including such things as the card number, expiration date, and others, is married to information from the device containing the card reader. According to systems and methods herein, the device may be any automated transaction system, such as a point of sale (POS) terminal or automatic teller machine (ATM), such that a data stream is created containing the card information as well is information about the requested transaction. Such information about the requested transaction may include a specific transaction identifier that includes at least the location of the terminal and the time of the transaction. Other information may include the terminal ID, a transaction code, the value of the transaction, etc. The data stream is forwarded to the card management agency. Upon receipt of the data stream, the transaction is logged into a database and given an authorization code. The data from the data stream may be further entered into a database for a specific financial institution, given a transaction identifier, and stored for archival purposes.

ATM fraud occurs through a variety of methods. One such method is “skimming”. This is where a magnetic reader is “piggy-backed” to the actual reader and a method is employed to obtain the associated PIN. Such method may be as simple as peering over a shoulder or sophisticated, such as use of a concealed video camera. Using this one method as an example, the fraud perpetrator obtains both the card magnetic information and the PIN. There are other methods to obtain this information, as well. Once the fraudster has this information, they can program a magnetic stripe on another card, visit a physical ATM location, and withdraw funds from the account.

Various methods may be used to combat this type of fraud. For example, at the card processing company, as transactions are recorded, authentication rules may be run that assess fraudulent trends on the card. For instance, a balance inquiry followed by multiple large withdrawals may trigger an alert to a fraud specialist, which would then trigger a possible suspension of the card. Unfortunately, this is a reactionary mode in that the fraud has already occurred and the fraudster has obtained some of the balance, which is a loss to the card issuer. The purpose of such reaction is to protect the remaining balance in the account on which the fraud has occurred. This does not have any impact on recuperating the losses other than through discussions with the legitimate cardholder (i.e., if the cardholder knows who used the card and made the withdrawal).

One way that fraudsters may attempt to avoid being traced is to try to conceal their identity at the ATM. A facemask or other device to conceal their facial features may be employed. Methods exist that use facial recognition processes internal to the ATM to determine if an actual or obstructed face is present. This may be accomplished by a variety of methods. One such method utilizes two cameras within the ATM machine. The two cameras are set at different angles to adjust for issues related to backlighting and angles to the subject's face, etc. A software program running internal to the ATM determines valid facial features using facial recognition algorithms in which the subject's facial features are compared to a known set of faces as a training set. Here, the goal is not to identify the actual face, but rather to determine if it is a face. In this method, a face that is covered by a ski mask, a novelty mask, or Halloween mask would be compared to known facial features and be determined to have a low probability that the subjects face is a real face. If it is determined that the probability of being a real face is low, an audible alarm or other warning would request that the subject make their face easier to see. After the obscuring device is removed, the algorithm run again. If a low probability of being a real face is detected again, the requested funds may not be dispensed.

As mentioned, if fraud has been determined to have occurred, a typical response would be to have a fraud specialist from the card processor contact the cardholder and attempt to determine who the perpetrator was. If the cardholder does not know who the perpetrator was and if the ATM is not owned by the card processing agency, there is little incentive to further investigate who the perpetrator may be.

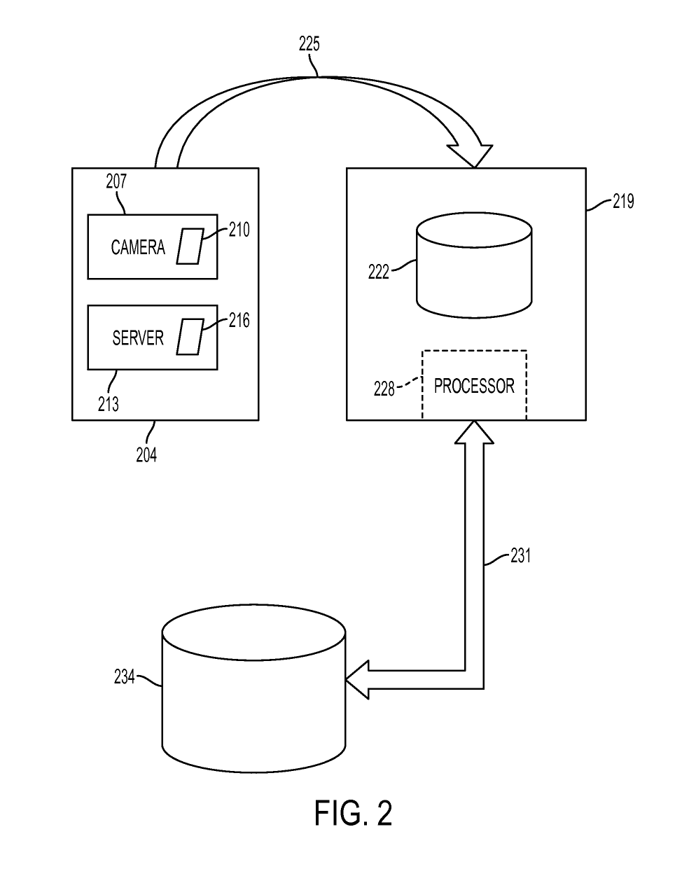

Referring to FIG. 2, an automated transaction system according to systems and methods herein is indicated generally as 204. The automated transaction system 204 may be a terminal of point of sale (POS) system or an automatic teller machine (ATM) and the like. The automated transaction system 204 includes a camera device 207. The camera device 207 acquires facial data 210 from a person located within visual range of the camera device 207 during a transaction between the person and the automated transaction system 204. The facial data 210 may be a video or other image obtained by the camera device 207. A server 213 is operatively connected to the automated transaction system 204. The server 213 receives the facial data 210 from the automated transaction system 204. The server 213 links the facial data 210 to a transaction identifier 216 associated with the transaction. The transaction identifier 216 includes the time and location of the transaction. As contemplated herein, the time may include the date, as well. The transaction identifier 216 may include other data such as a terminal identification, a transaction number, an authorization number, etc.

The server 213 is operatively connected to a centralized repository 219, which may include a database 222. The database 222 may be any organized collection of the facial data 210. Additionally, the database 222 may have a database management system designed to allow the definition, creation, querying, update, and administration of database 222. In some cases, the database may comprise a relational database, with an appropriate query language, as would be known by one of ordinary skill in the art. A first network 225 connects the server 213 with the centralized repository 219. The centralized repository 219 stores the facial data 210 and the transaction identifier 216. A facial recognition processor 228 is operatively connected to the centralized repository 219. A second network 231 connects the facial recognition processor 228 to external databases 234, which may include private, public, and law enforcement databases. As used herein, either or both of the first network 225 and second network 231 may comprise, for example, the Internet, a local area network (LAN), a wide area network (WAN), and/or a wireless network. The external databases 234 may include various web sources, including but not limited to, Facebook, Instagram, photobucket, etc., as well as police agencies' databases (e.g., mug shots). The facial recognition processor 228 can compare the facial data 210 associated with the transaction identifier 216 to facial profiles from the public and law enforcement databases 234.

Facial recognition is a process for automatically identifying or verifying a person from an image or a video frame from a picture source. Typically, the image or video frame is in a digital format. One of the ways in which facial recognition may be accomplished in to compare selected facial features from the image with images in a facial database. Some facial recognition processes identify faces by extracting landmarks, or features, from an image of the subject's face.

According to exemplary systems and methods herein, a particular facial recognition process may analyze the relative position, size, and/or shape of the subject's eyes, nose, cheekbones, jaw, ears, hair, etc. These features may then be used to search for other images with matching features. Other facial recognition processes normalize a gallery of face images and then compress the face data, only saving the data in the image that is useful for face detection. A probe image is then compared with the face data. One of the earliest, successful systems is based on template matching techniques applied to a set of salient facial features, providing a sort of compressed face representation. In general, facial recognition processes can be divided into two main approaches. The first approach is a geometric method that may look at distinguishing features of an image. The second approach is a statistical photometric method that that may distill an image into values and comparing the values with templates to eliminate variances.

The facial recognition processor 228 generates potential identity matches based on the facial profiles obtained from the public and law enforcement databases 234. The facial recognition processor 228 can then output the potential identity matches to an authorized subscriber.

According to exemplary systems and methods herein, the facial data 210, which may be video or image files from ATM or POS locations, can be routinely [real-time or on a schedule] stored in the centralized repository 219. Alternatively, the facial data 210 can be uploaded on demand to the centralized repository 219. The server 213 ensures that the facial data 210 is tagged with the location and time the image was acquired. If a fraud has been determined to occur, a card processing company who has contracted with the owner of the centralized repository 219 can ask for an analysis related to a specific time and location. The facial data 210 from that time and location is then processed for facial recognition. A face that is identified is then compared using standard facial recognition and matching technologies to images available on various web sources and police mug shots. Based on the analysis, a listing of possible matches is created. The list may be sent to the originator of the request for further use, or further analysis may be done via human interaction at the centralized repository 219 in order to try to ascertain the identification of the matched images via traditional web investigations. If a reasonable identification is made, the information can then be sent to the proper authorities for further prosecutorial and investigative actions.

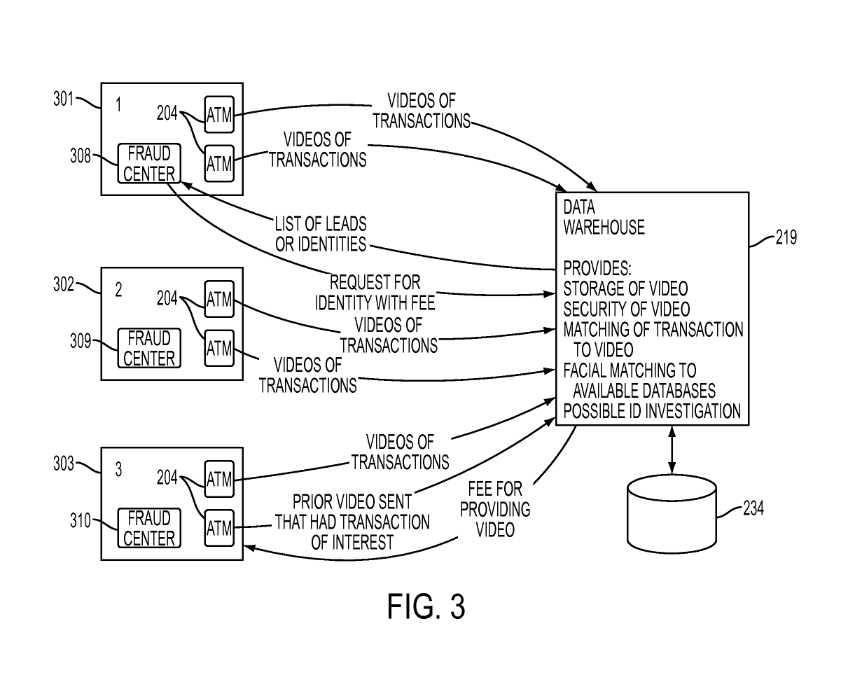

FIG. 3 is for illustrative purposes only, and shows various fraud centers and ATMs localized within the same institution. It is contemplated that ATMs can be located in a bank, in merchant boxes, and other locations. Additionally, there may be card issuers that don't own ATMs as well as ATMs that are owned by merchants not associated with a bank or other financial institution. Furthermore, fraud centers may be located inside card issuer boxes, with a bank, or with a card issuer.

As shown in FIG. 3, exemplary systems and methods described herein can be used as a business model having the following or similar attributes:
1. Linking one or more photographs and/or one or more videos from ATM and/or POS transactions at an automated transaction system 204 to a transaction identifier. The photographs and/or videos provide the facial data 210 described above.
2. Linking the transaction location, time, and other transaction information to the same transaction identifier.
3. The photographs and/or videos are obtained from a plurality of ATMs that may be owned by banks, merchants, and other card issuers such as indicated as 301, 302, 303 in FIG. 3. The photographs and/or videos are stored the centralized repository 219 [together with or separate from other transaction information storage]. In FIG. 3, the centralized repository 219 is labeled as a Data Warehouse.
4. When fraud is claimed by a cardholder, a fraud center 308, 309, 310 at an investigating institution, requests that the photographs and/or videos be obtained for the given transaction identifier.

In one example, as shown with reference to card issuer 1 (301) in FIG. 3, the centralized repository 219 pulls the photographs and/or videos, performs facial recognition on the video, compares the facial data 210 from the photographs and/or videos to facial profiles from external databases 234, such as private, public, and law enforcement databases, and generates a list of potential leads, identifiers, or other information to be sent to the fraud center 308 at the investigating institution for a fee. The fraud center 308 then performs human investigation to attempt to obtain the identity of the person in the photographs and/or videos.

In another example, as shown with reference to card issuer 2 (302) in FIG. 3, the centralized repository 219 does all the analysis. That is, the centralized repository 219 pulls the photographs and/or videos, performs facial recognition on the video, compares the facial data 210 from the video to facial profiles from public and law enforcement databases 234, and performs human investigation to attempt to identify the person in the photographs and/or videos. The centralized repository 219 then provides the name and contact information to the fraud center 309 of the investigating institution for a fee. After identification, the contact information may be forwarded by the fraud center 309 to the proper authorities for further investigation and prosecution.

Several financial models are contemplated for monetizing services as described herein. For example, if, as described above, the contact information is forwarded to the proper authorities for further investigation and prosecution and the prosecution results in restitution, a percentage of funds reclaimed may be sent to the institution that provided the photographs and/or videos. In another example, if prosecution results in restitution, a percentage of the funds reclaimed may be sent to the data warehouse (centralized repository 219) and a percentage of reclaimed funds may be sent to the merchant, bank, or other appropriate institution that provided the photographs and/or videos. In some case, a percentage of reclaimed funds may be sent to the manufacturer of the ATM. In yet another example, if prosecution results in restitution, a percentage of the funds reclaimed may sent to the data warehouse (centralized repository 219) and the institution providing the video may be paid a flat fee or a per picture/video fee by the data warehouse (centralized repository 219), as illustrated with reference to card issuer 3 (303) in FIG. 3.

As described above, one possible financial model contemplated by the exemplary systems and methods herein is that the ATM video holders provide the videos to the video data warehouse without charge (i.e., free). The card processor/fraud center may pay a nominal flat fee for each investigation undertaken. The facial recognition processing facility receives a percentage of recovered funds and the video provider receives a percentage of the recovered funds. The card processing agency retains the remainder. This way the card processing agency has more control over which fraud actions they deem worthwhile to pursue and prosecute. Other financial models can also be envisioned.

The above examples are described with reference to an ATM; it is contemplated that similar models apply to POS systems, as well. For example, financial incentives may be provided for photographs and/or videos from camera system owned and operated by a merchant, not specifically affiliated with a bank or card issuer. A merchant could own the fraud center, in this case. In another example, a card issuer who provides the camera with the card scanner could own a POS camera.

FIG. 4 is a flow diagram illustrating the processing flow of an exemplary method according to systems and methods herein. The method is useful for identifying perpetrators of ATM fraud. At 414, a subscription fee is collected for defined services for collecting, processing, and analyzing facial data. At 426, facial data is acquired from a person conducting a transaction with an automated transaction system. The automated transaction system comprises a camera device. The facial data comprises an image obtained by the camera device. The facial data is linked to a transaction identifier associated with the transaction, at 438. The transaction identifier comprises at least time and location of the transaction. The facial data and the transaction identifier are stored in a centralized repository connected to the automated transaction system, at 450. A request from an authorized subscriber is received, at 462. The request is to identify the person based on the transaction identifier because the transaction is deemed fraudulent. The facial data associated with the transaction identifier is compared to facial profiles obtained from external databases, at 474, such as private, public, and law enforcement databases. At 486, potential identity matches are generated based on the facial profiles. At 498, the potential identity matches are output to the authorized subscriber for further prosecutorial and/or investigative actions.

Aspects of the present disclosure are described herein with reference to flowchart illustrations and/or block diagrams of methods, apparatus (systems), and computer program products according to various systems and methods. It will be understood that each block of the flowchart illustrations and/or two-dimensional block diagrams, and combinations of blocks in the flowchart illustrations and/or block diagrams, can be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

According to a further system and method herein, an article of manufacture is provided that includes a tangible computer readable medium having computer readable instructions embodied therein for performing the steps of the computer implemented methods, including, but not limited to, the method illustrated in FIG. 4. Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein. A computer readable storage medium may be, for example, but not limited to, an electronic, magnetic, optical, electromagnetic, infrared, or semiconductor system, apparatus, or device, or any suitable combination of the foregoing. Any of these devices may have computer readable instructions for carrying out the steps of the methods described above with reference to FIG. 4.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Furthermore, the computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

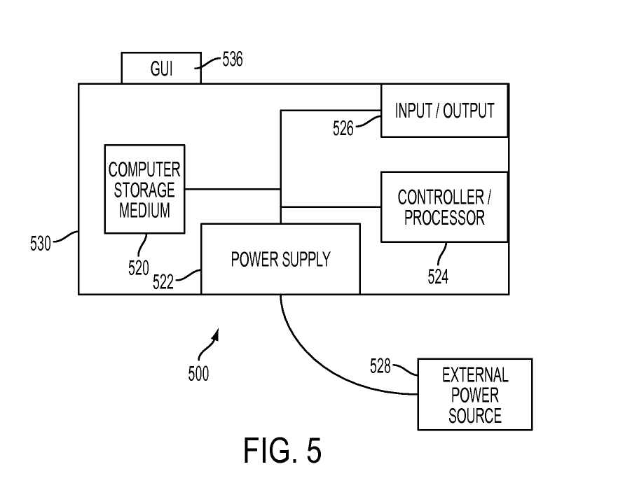

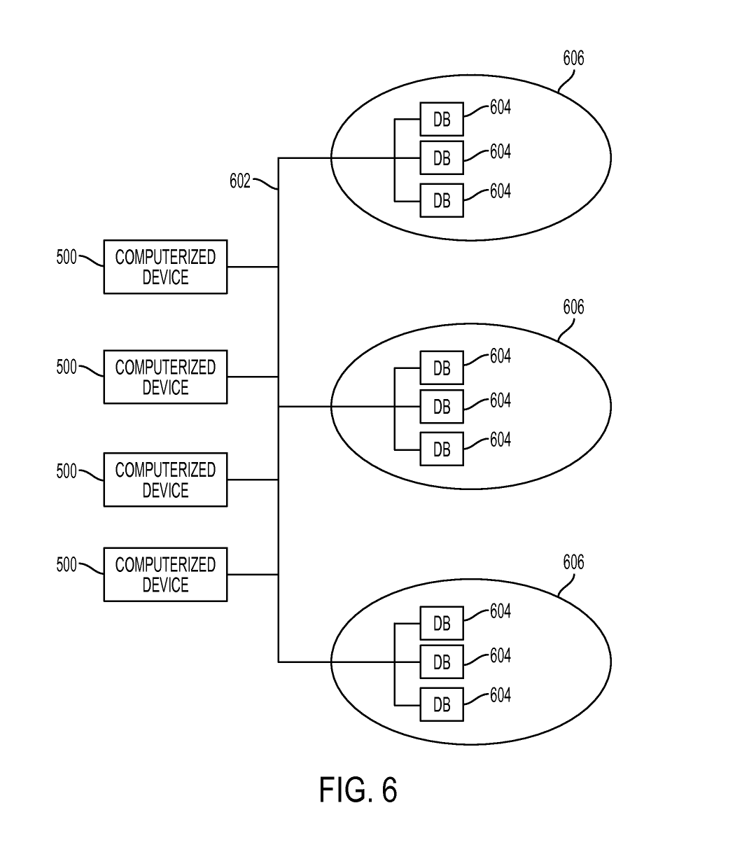

FIG. 5 illustrates a computerized device 500, which can be used with systems and methods herein and can comprise, for example, a personal computer, a portable computing device, etc. The computerized device 500 includes a controller/processor 524 and a communications port (input/output device 526) operatively connected to the controller/processor 524. As described above, the controller/processor 524 may also be connected and to a computerized network 602 external to the computerized device 500, such as shown in FIG. 6. In addition, the computerized device 500 can include at least one accessory functional component, such as a graphic user interface assembly (GUI) 536 that also operates on the power supplied from the external power source 528 (through the power supply 522).

The input/output device 526 is used for communications to and from the computerized device 300. The controller/processor 524 controls the various actions of the computerized device. A non-transitory computer storage medium 520 (which can be optical, magnetic, capacitor based, etc.) is readable by the controller/processor 524 and stores instructions that the controller/processor 524 executes to allow the computerized device 500 to perform its various functions, such as those described herein. Thus, as shown in FIG. 5, a body housing 530 has one or more functional components that operate on power supplied from the external power source 528, which may comprise an alternating current (AC) power source, to the power supply 522. The power supply 522 can comprise a power storage element (e.g., a battery) and connects to an external power source 528. The power supply 522 converts the external power into the type of power needed by the various components.

In case of implementing the systems and methods herein by software and/or firmware, a program constituting the software may be installed into a computer with dedicated hardware, from a storage medium or a network, and the computer is capable of performing various functions if with various programs installed therein.

In the case where the above-described series of processing is implemented with software, the program that constitutes the software may be installed from a network such as the Internet or a storage medium such as the removable medium.

Those skilled in the art would appreciate that the storage medium is not limited to a peripheral device having the program stored therein, which is distributed separately from the device for providing the program to the user. Examples of a removable medium include a magnetic disk (including a floppy disk), an optical disk (including a Compact Disk-Read Only Memory (CD-ROM) and a Digital Versatile Disk (DVD)), a magneto-optical disk (including a Mini-Disk (MD) (registered trademark)), and a semiconductor memory. Alternatively, the computer storage medium 520 may be a hard disk, or the like, which has the program stored therein and is distributed to the user together with the device that contains them.

As will be appreciated by one skilled in the art, aspects of the devices and methods herein may be embodied as a system, method, or computer program product. Accordingly, aspects of the present disclosure may take the form of an entirely hardware system, an entirely software system (including firmware, resident software, micro-code, etc.) or an system combining software and hardware aspects that may all generally be referred to herein as a “circuit,” “module”, or “system.” Furthermore, aspects of the present disclosure may take the form of a computer program product embodied in one or more computer readable medium(s) having computer readable program code embodied thereon.

Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a Read Only Memory (ROM), an Erasable Programmable Read Only Memory (EPROM or Flash memory), an optical fiber, a magnetic storage device, a portable compact disc Read Only Memory (CD-ROM), an optical storage device, a “plug-and-play” memory device, like a USB flash drive, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods, and computer program products according to various devices and methods herein. In this regard, each block in the flowchart or block diagrams may represent a module, segment, or portion of code, which comprises one or more executable instructions for implementing the specified logical function(s). It should also be noted that, in some alternative implementations, the functions noted in the block might occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As shown in FIG. 6, exemplary systems and methods herein may include various computerized devices 500 and databases 604 located at various different physical locations 606. The computerized devices 500 and databases 604 are in communication (operatively connected to one another) by way of a local or wide area (wired or wireless) computerized network 602.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the systems and methods described herein. Similarly, scanners and other similar peripheral equipment are available from Xerox Corporation, Norwalk, Conn., USA and the details of such devices are not discussed herein for purposes of brevity and reader focus.

The terminology used herein is for the purpose of describing particular devices and methods only and is not intended to be limiting of this disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, the terms ‘automated’ or ‘automatically’ mean that once a process is started (by a machine or a user), one or more machines perform the process without further input from any user.

The corresponding structures, materials, acts, and equivalents of all means or step plus function elements in the claims below are intended to include any structure, material, or act for performing the function in combination with other claimed elements as specifically claimed. The descriptions of the various devices and methods of the present disclosure have been presented for purposes of illustration, but are not intended to be exhaustive or limited to the devices and methods disclosed. Many modifications and variations will be apparent to those of ordinary skill in the art without departing from the scope and spirit of the described devices and methods. The terminology used herein was chosen to best explain the principles of the devices and methods, the practical application or technical improvement over technologies found in the marketplace, or to enable others of ordinary skill in the art to understand the devices and methods disclosed herein.

It will be appreciated that the above-disclosed and other features and functions, or alternatives thereof, may be desirably combined into many other different systems or applications. Those skilled in the art may subsequently make various presently unforeseen or unanticipated alternatives, modifications, variations, or improvements therein, which are also intended to be encompassed by the following claims. Unless specifically defined in a specific claim itself, steps or components of the systems and methods herein should not be implied or imported from any above example as limitations to any particular order, number, position, size, shape, angle, color, temperature, or material.

1. A system, comprising:
an automated transaction system comprising a camera device acquiring facial data from an unknown person located within a visual range of said camera device during a transaction between said unknown person and said automated transaction system, said facial data comprising an image obtained by said camera device;
a server operatively connected to said automated transaction system, said server receiving said facial data from said automated transaction system, said server linking said facial data to a transaction identifier associated with said transaction, said transaction identifier comprising at least time and location of said transaction;
a centralized repository operatively connected to said server;
a first network connecting said server with said centralized repository, said centralized repository storing said facial data and said transaction identifier;
a facial recognition processor operatively connected to said centralized repository; and
a second network connecting said facial recognition processor to external databases comprising, private databases, public databases and law enforcement databases,
upon receiving a request from an authorized subscriber to identify said unknown person based on said transaction identifier, said facial recognition processor comparing said facial data associated with said transaction identifier to facial profiles from one of said external databases,
said facial recognition processor generating potential identity matches based on said facial profiles, and
said facial recognition processor outputting said potential identity matches to said authorized subscriber.

2. The system according to claim 1, said automated transaction system comprising an automatic teller machine or point of sale system.

3. The system according to claim 1, said image obtained by said camera device comprising video or photographs.

4. The system according to claim 1, said centralized repository further comprising a database.

5. The system according to claim 4, said centralized repository storing said facial data and said transaction identifier in said database.

6. The system according to claim 1, said facial recognition processor comprising a special purpose machine specialized for processing image data.

7. The system according to claim 6, said facial recognition processor comprising application specific integrated circuits (ASIC's) specialized for handling of image processing operations, processing image data, and comparing acquired image data to stored images from external sources.

8. A method comprising:
acquiring facial data from an unknown person conducting a transaction with an automated transaction system, said automated transaction system comprising a camera device, said facial data comprising an image obtained by said camera device;
linking said facial data to a transaction identifier associated with said transaction, said transaction identifier comprising at least time and location of said transaction;
storing said facial data and said transaction identifier in a centralized repository connected to said automated transaction system;
comparing said facial data associated with said transaction identifier to facial profiles obtained from an external database, comprising private databases, public databases and law enforcement databases; and
generating potential identity matches based on said facial profiles.

9. The method according to claim 8, said automated transaction system comprising an automatic teller machine or point of sale system.

10. The method according to claim 8, said image obtained by said camera device comprising video or photographs.

11. The method according to claim 8, said centralized repository further comprising a database.

12. The method according to claim 11, said method further comprising storing said facial data and said transaction identifier in said database.

13. The method according to claim 8, further comprising:
converting said facial data of said unknown person to a digital set of facial features;
obtaining facial profiles from at least one of said external databases;
processing said facial profiles obtained from said at least one of said external databases said processing comprising converting digital images of pixel values into a database of facial profiles; and
searching said database of facial profiles for other images that match said digital set of facial features.

14. The method according to claim 8, outputting said potential identity matches to an authorized subscriber for further prosecutorial and/or investigative actions.

15. A method comprising:
collecting a subscription fee for defined services for collecting, processing, and analyzing facial data;
acquiring facial data from an unknown person conducting a fraudulent transaction with an automated transaction system, said automated transaction system comprising a camera device, said facial data comprising an image obtained by said camera device;
linking said facial data to a transaction identifier associated with said fraudulent transaction, said transaction identifier comprising at least time and location of said fraudulent transaction;
storing said facial data and said transaction identifier in a centralized repository connected to said automated transaction system;
receiving a request from an authorized subscriber to identify said unknown person based on said transaction identifier;
comparing said facial data associated with said transaction identifier to facial profiles obtained from at least one of private databases, public databases, or law enforcement databases;
generating potential identity matches based on said facial profiles; and
outputting said potential identity matches to said authorized subscriber for further prosecutorial or investigative actions.

16. The method according to claim 15, said automated transaction system comprising an automatic teller machine or point of sale system.

17. The method according to claim 15, said image obtained by said camera device comprising video or photographs.

18. The method according to claim 15, said centralized repository further comprising a database.

19. The method according to claim 18, said method further comprising storing said facial data and said transaction identifier in said database.

20. The method according to claim 15, further comprising:
determining facial features of said unknown person based on said facial data;
obtaining facial profiles from said at least one of said private databases, public databases and said law enforcement databases; and
searching said facial profiles for other images with matching facial features.
